(19) United States
(12) Patent Application Publication
(10) Pub. No.: US 2025/0362649 A1
(43) Pub. Date: Nov. 27, 2025

(54) AUTONOMOUS MACHINE WITH ADAPTIVE CONTROLLER

(71) Applicant: KELLY ROBIN LTD, Bristol (GB)

(72) Inventor: Robin HOWE, Bristol (GB)

(21) Appl. No.: 18/868,197

(22) PCT Filed: May 30, 2023
(86) PCT No.: PCT/EP2023/064420

§ 371 Date: Nov. 22, 2024

(30) Foreign Application Priority Data
May 30, 2022 (GB) 2207928.9

(51) Int. Cl. G05B 13/04

(52) U.S. Cl. CPC G05B 13/041; G05B 13/048

(57) ABSTRACT

An autonomous machine arranged to provide an observable measure of the mechanical energy dissipated by the machine relative to that stored by the machine, so that the decision making of the machine's control system can be based on a real energetic stress of the machine. The autonomous machine has a control system with predictive models for the internal and external environments. Both predictive models are based on the same set of information representing a common energetic basis of the machine. The set of information includes: (i) a plurality of reciprocal signals indicative of the machine's direct interactions, and (ii) a plurality of non-reciprocal signals indicative of information that is available to the machine without requiring it to expend energy. The plurality of non-reciprocal signals includes emulated signals where needed to ensure that the predictive models for the internal and external environments are based on an equivalent set of parameters.

### FIELD OF THE INVENTION

The present invention relates to a machine having an offline rechargeable power supply (e.g. rechargeable battery or the like) and a control system configured to autonomously maintain the machine's positive energetic state by monitoring the interaction of the machine with its internal and external environments.

### BACKGROUND

A machine is an assembly of one or more parts intended to gain some mechanical or other advantage in performing work. Autonomous machines (also referred to herein as “automatons”) typically operate within defined environments using a control system. Autonomous machines normally include an offline energy storage capacity and the means to restore it, commensurate with the finite capacity of the offline store and the machine's autonomous function.

It is desirable for a machine to limit its energy losses by maximising its energy efficiency. For an automaton in particular, maximising efficiency promotes the maximising of the time periods between which the machine is required to restore its energy reserve, but also where a functioning automaton must store sufficient energy to facilitate that restoration.

There exists a plurality of methods to implement a machine controller, where its complexity somewhat reflects the complexity of the machine it controls. A controller can range from a simple mechanical device to complex electronic processing means that may also employ a plurality of electromechanical or other transducers, as sensors or as mechanical actuators.

A machine controller can employ feedback, wherein a measure of the machine's output serves as a driver for its input. Within the range of motion permitted by the machine's mechanical capabilities, sufficient and stable gain within that feedback system bestows the machine with a performance limited primarily by its sensing accuracy.

A machine controller may also employ feedforward, wherein previously acquired knowledge embedded in a model of the machine or its environment enables the prediction of the (nominally) optimal machine action via an estimate of the most probable outcome, possibly from a “Markov Chain”, explicitly or otherwise.

Rather than incorporate a prior obtained, hard encoding of information, an “adaptive” machine controller can exploit a learning capacity, wherein the controller updates its predictive model according to events and outcomes measured by the machine, thereby “adapting” the model, and therefore the machine, to its environment.

Adaptive model optimisation via gradient ascent/descent methods is typically commensurate with the “InfoMax Principle”, wherein, driven by overarching negative feedback, minimising prediction errors serves to maximise accuracy, and minimising the predictor complexity serves to maximise its efficiency (in the controller and in the resultant action) [1]. However, the convergence afforded by the machine controller's inherent negative feedback likely realises a locally optimal action that is not necessarily coincident with the globally optimal result. The necessary modulation of that convergence via additional positive feedback to permit the search for better non-local solutions is known as “wandering”.

More complex adaptive machine controllers may employ so-called “deep learning” methods, wherein one or more “hidden layer” establishes intermediate correlations between the controller inputs and outputs. A Helmholtz machine, for example, may employ a circuitous “neural network” that resembles somewhat the information flux in the central nervous system [2], wherein an adaptive “recognition” element models the machine controller inputs (sensations), and an adaptive “generative” element models the machine's outputs (actions).

A superset of control system analyses applicable to machine controllers is the “Free Energy Principle” [3], that describes the minimisation of “free energy” in a feedback system [4]. Note that “free energy” is a theoretical measure rather than real, thermodynamic energy, however. A controller based on the “Free Energy Principle” can yield a Bayesian inferential network [5], wherein posterior (output) predictions are developed from the conditional probabilities of prior predictions, and wherein free energy provides a measure of the “surprise” difference between the controller's prediction and its sensed reality.

In an ideal inferential network, the recognition or generative models are updated such as to minimise their information redundancy (or reduce divergence from the maximally efficient representation) whereby well-defined modelled objects cause data “clusters” that provide the basis for higher level representations [6].

Bounded by the sensory mode and the acuity therein, such a controller leads to the identification or inference of data clusters from the information incident at the machine's interfaces that provide for the subsequent development of a layered model in which modelled components are differentiated by so-called “Markov Blankets” [7]. The Markov Blankets provide a “scale” to the model, wherein low-level model components are subsumed in a higher-level model component and assigned some “value”, referred to as “reward” or “utility” (or complementary-wise “loss” or “cost”), and according to which the machine controller affords some action as determined at that particular scale.

### SUMMARY OF THE INVENTION

At its most general, the present invention provides an autonomous machine (e.g. a computer-controlled device) arranged to provide an observable measure of the mechanical energy dissipated by the machine relative to that stored by the machine, so that the decision making of the machine's control system can be based on a real energetic stress of the machine.

In particular, the invention may provide an autonomous machine having a control system with predictive models for the internal and external environments, where both predictive models are based on the same set of information, which represent a common energetic basis of the machine. The set of information may include: (i) a plurality of reciprocal signals conveyed on reciprocating channels, wherein the plurality of reciprocal signals are indicative of the machine's direct interactions (“near field”), and (ii) a plurality of non-reciprocal signals conveyed on non-reciprocating channels, wherein the plurality of non-reciprocal signals are indicative of information that is available to the machine without requiring it to expend energy (“far field”), and wherein the plurality of non-reciprocal signals include emulated signals where needed to ensure that the predictive models for the internal and external environments are based on an equivalent set of parameters. The control system may also provide a dedicated parallel pathway for a common mode signal within the machine's internal environment. This ensures that the signals within the set of parameters that relate to the common mode are orthogonal to differential mode signals in both the predictive models, thereby enabling the predictive models to distinguish between internal and external power dissipation and thus provide a true indicative of the energetic stress on the machine.

The invention can be differentiated from the prior art that exploit high order representations because higher order components of the predictive models are not “insulated” from lower orders by Markov Blankets. By means of the architecture set forth herein, only the parts (e.g. layers) of the predictive models with errors will cause a flux in a feedback loop between those models, which thereby ensures the real energetic basis of the machine's mechanical interactions permeates throughout the relevant machine controller part, and renders errors at the interface of the machine.

The invention can be implemented on any autonomous machine that, through training or otherwise, is capable of maintaining itself in its environment, wherein the machine includes an offline energy storage capacity, rather than a permanently engaged power supply, and wherein the machine is capable of restoring its offline energy store by interacting mechanically within its environment.

Thus, according to the invention there is provided a machine capable of autonomous operation, the machine comprising: a rechargeable offline power supply; a physical interface through which the machine interacts with an external environment, the physical interface comprising: a reciprocating interface operable in a differential mode and a common mode, wherein the reciprocating interface is configured to provide motion via a differential mode output, and to provide motion cancellation of a common mode output; and a non-reciprocating interface configured to interact passively with the external environment via a non-reciprocating input (e.g. a sensor or the like); a first control element configured to control internal and external operations of the machine and maintain a positive energetic state of the machine; and a second control element disposed between the first control element and the physical interface to mediate information exchange therebetween, wherein the second control element is configured to communicate with the physical interface via a first set of reciprocal information channels and to communicate with the first control element via a second set of reciprocal information channels, wherein the first set of reciprocal information channels includes an input channel configured to convey information into the machine from the non-reciprocating input and an emulated output channel that forms a reciprocal pair with an input channel, wherein the second control element comprises a first predictive model arranged to predict communications on the first set of reciprocal information channels, and a second predictive model arranged to predict communications on the second set of reciprocal information channels, wherein the first predictive model and the second predictive model are both adaptive models bound in a feedback arrangement to minimise an error energy flux between the first and second sets of reciprocal information channels, and wherein the first control element is configured to maintain a common mode bias at the physical interface, and comprises a common mode regulator arranged to establish an independent parallel common mode path, that appears within the internal environment of the machine.

The control system architecture as defined herein provides particular advantages for the ability of the predictive models to discriminate between clusters of information that represent different aspects of the internal and external environments that the machine can infer. In particular, the combination of (i) ensuring that the common mode signal is orthogonal to the other signals on both the input and output side of the second control element, and (ii) using channel emulation to establish fully reciprocal information channels on both sides of the second control element means that the predictive models have a common energetic basis in which a cluster of information relating to a “near field” portion (relating to the reciprocating interface) can be distinguished from a cluster of information relating to a “far field” portion (relating to the non-dissipating interface), and in which it is possible to discriminate between clusters of information within the near field portion that relate to the internal and external effects. This ability to discriminate manifests itself in an improved sensitivity of the predictive models to internal and external effects.

The rechargeable offline power supply may be a battery or other suitable portable power source. In some examples the power source may include a substrate that forms part of the machine, e.g. a consumable part of a housing or other body of the machine.

The physical interface may comprise any suitable structure for exerting force on an environment to achieve a physical effect. In particular the reciprocating interface may be configured to enable the machine to move within the external environment, e.g. to access a position in which the rechargeable offline power supply can be recharged. As such, the reciprocating interface establishes a real energetic basis between the first control element and the physical interface. The reciprocating interface may include a pair of reciprocating servomotors, for example. The reciprocating interface may be configured to provide motion from a differential mode output, and to provide motion cancellation from its common mode output. An independent set of reciprocating elements is needed per dimension in which motion is required.

The non-reciprocating interface may be any suitable passive sensor for detecting a property of the external environment. The sensor may be an image sensor or scanner configured to detect information about the machine's surroundings. Alternatively or additionally it may include an environment sensor, e.g. to measure temperature, humidity, or the like. The non-reciprocating interface may also comprise a (nominal) output, such as an illumination source. However, it can be understood that such an output is non-dissipative from the point of view of mechanical energy delivered into the environment. The non-dissipative nature of the non-reciprocating interface means that it provides a non-reciprocal information channel, e.g. indicative of the far field of the machine, which is converted to a reciprocal pair by the emulated output channel, which is itself inherently non-dissipative. If the non-reciprocating interface also comprises a (nominal) output, the first set of reciprocal information channels further includes an emulated input channel that forms a reciprocal pair with an output channel conveying information to the non-reciprocating interface. In the architecture presented herein, a reciprocal pair is formed for each non-reciprocal input or output. The machine may thus have a plurality of non-reciprocal channels, each sourced from either the first control element or the physical interface, and hence a plurality of corresponding emulated channels.

The non-reciprocating channels and their corresponding emulated channels are replicated in the second set of reciprocal information channels, so that the first and second predictive models operate on the same information set. However, in some cases, the emulated channels need not “reach through” completely between the first control element and the physical interface. Instead they may terminate at the second control element, thereby forming stub channels. One example of a stub channel may be the output from a sequence memory in the first control element. This output may influence future actions, but is not required to feed into the physical interface. Another example of a stub channel may be an input from a colour detector in the physical interface. This input may form part of the far field information available to the machine, but is not required to feed in to the first control element.

The first control element may be configured to regulate the machine's positive energetic state, for example using a suitably configured feedback loop. The feedback loop for the machine's positive energetic state may comprise one or more subsidiary feedback loops. For example, the first control element may employ a first feedback loop to control the internal environment of the machine, and a second feedback loop to cause the motion required to restore its off-line power supply. The first control element may be implemented using a control model that associates actions or sequences thereof with outcomes. For example, the model may encode motion instructions capable of controlling the physical interface to enable the machine to function in its environment. In one example, the control model May comprise a memory arranged to store one or more sequences of actions, each associated with an outcome that records the impact of the sequence on the objectives of the feedback loop.

The model may have objectives or drivers that operate to determine a priority for available actions in a given scenario. For example, a fundamental driver may relate to regulating the machine's positive energy state. Other drivers may be arranged in a cascade thereafter, thereby forming a hierarchy that reflects their decreasing priority. Having a cascade of drivers in the first control element may also permit one or more drivers to be suspended until such time as the machine has acquired sufficient knowledge to ensure its long-term energetic stability.

The energetic state of the machine may be linked with its operation state. For example, the machine may be arranged to terminate operation if the stored energy becomes zero leads to the cessation of the machine. The first control element may be configured to control the cascade of drivers on this basis.

The first control element may further incorporate an adaptive learning module arranged to update its model. The model may be adapted using Pavlovian learning, for example.

The common mode bias maintained by the first control element may be arranged to cause the reciprocating interface outputs to have a positive internal power dissipation. The common mode regulator may thus be configured to regulate the internal dissipation, via either a feedback or feedforward arrangement relative to some reference.

In some embodiments, the internal dissipation from the common mode bias may be used to provide heating to emulate or create a thermogenic machine, wherein a thermal sensor is utilised to adjust the reference for the common mode regulator to compensate for changes in internal temperature.

The independent parallel common mode path may be physically defined within the machine, or may be an emulated path formed within the first control element.

The first set of reciprocal information channels and the second set of reciprocal information channels may both comprise a plurality of reciprocating channel pairs in order to preserve a real energetic basis established in the physical interface at the second control element. Where an input to the second control element is non-reciprocal, for example because it relates to the non-reciprocating interface, the second control element is configured to emulate a corresponding output in order to create a reciprocal pair. Each emulated reciprocating channel is arranged to be nominally non-dissipative.

The first predictive model is configured to generate an output that comprises a signal on one or more of the first set of reciprocal information channels. The second control element may be arranged such that the predictions it forms from its first model (which may represent the external environment), even if from a single sensing input, is projected to all the sensing inputs encompassed by the physical interface. Similarly, the second predictive model is configured to generate an output that comprises a signal on one or more of the second set of reciprocal information channels. Accordingly, an error flux apparent on only a subset of the relevant reciprocal information channels can still map to information on all channels.

If the predictive models are sufficiently accurate that no error is discerned in either model, the second control element is operating in a converged state, and there exists no flux of information exchange through the second control element between the first control element and the physical interface. The advantage of this situation is that the model (and therefore the machine) becomes optimally adapted to its environment. Only when an error is discerned in either predictive model does a flux of information flow within the second control element, whereupon a local negative feedback loop becomes apparent in which the model impedances are driven to equality. This arrangement can be used to adapt the predictive models, such that new model components can be identified and added during operation of the machine.

In one embodiment, the path to convergence in the feedback loop formed within the second control element may be driven in part by an error component on the common mode output.

During the instants that define the path to convergence, the control system architecture set forth herein endows the machine with a relative energetic model of itself that is rendered in parallel with, and indiscernible from, a sensed energetic reality forming its near field interaction projected within a far field model external environment. This means that the predictive model can be adapted based on information in which the machine's near field is distinguished from its far field, where the near field is that in direct contact with the machine and dissipating real mechanical power (internally or externally). Moreover, the provision of the common mode regulator enables discrimination between the machine's internal and external power dissipation, which in turn provides information indicative of the energetic stress on the machine.

When the second control element operates is a diverged stage (i.e. when there are errors in one or both predictive models), the model errors in the second control element are observable at the physical interface or at the point of reciprocating channel emulation (if not the same). The errors may be effectively rendered at the physical interface in the appropriate sensory mode.

The first predictive model and second predictive model may each employ a layered or hierarchical model. When arranged as discussed above, all layers below the source of the error are essentially cancelled out, such that the energetic information rendered in the physical interface is caused by the higher hierarchical layers in the models being converged upon.

The first and second predictive models, and optionally the control model in the first control element, may be modular models comprising a plurality of interchangeable units, such as layers in a hierarchical model that can be switched in and out as required.

In some embodiments, the path to convergence in the second control element can be modulated such that overall convergence encompasses shorter periods of divergence, i.e. “wandering”. For example, in an embodiment where the first control element comprises memory of sequences and outcomes, each outcome being associated with positive or negative score for each driver units, the outcomes can be used to modulate the behaviour of the second control element, for example by constraining the scope of a Bayesian search for a local minimum. In another example, the second control element may be modulated based on the energy that is available, which information is available from the first control element. The machine may be configured to inhibit wandering until the model in the first control element is operating in a stable manner.

The machine may be part of a group of machines that have the same control architecture. In some embodiments, the second control element may be arranged to introduce a perturbation in the first predictive model and/or the second predictive model in order to introduce variation in the models across the group of machines. In particular, the perturbation may be introduced into a layer of the first or second predictive model when in the converged state. In this scenario, the perturbation can become a permanent part of the learned model.

The machine may be arranged in a distributed manner, e.g. over one or more physical sub-components which are interconnected in a suitable manner, e.g. via a wireless network, and wherein the predictive models are established across all the physical sub-components and the interfaces therein.

In one embodiment, the first control element may itself be configured to influence the learning process within the second control element by providing non-linear responses on one or more of the second set of reciprocal information channels.

The machine may be operable in both physical (real) and virtual (e.g. simulated) environments, and references to the “external environment” of the machine herein may be interpreted accordingly.

The first and second control elements may be implemented as a computer-controlled unit, e.g. as software or firmware running on a processor within the machine.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a schematic diagram showing the functional components of an autonomous machine that is an embodiment of the invention;

FIG. 2 is a schematic diagram showing the interrelationship of the predictive models used in a control system of an autonomous machine according to the present invention;

FIG. 3 is a schematic diagram showing energetic flux when the predictive models of the control system are operating in a converged state; and

FIG. 4 is a schematic diagram showing energetic flux when the predictive models of the control system are operating in a diverged state.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The arrangements described herein provides two adaptive predictors arranged between the interface of a machine controller and its operating environment. A first predictor predicts events sensed in the machine's environment; The second predictor predicts the machine controller's response.

The invention causes the calibration of the two predictors via a measure of some common mode output orthogonal to the differential mode signals that cause or measure the machine's differential power output. In the arrangement described, the adaptive predictors can be considered as controlling the (nominally mechanical) impedances presented to the machine interface and controller.

The predictors are connected in a local loop such as to minimise the information (energy) flowing therein (nominally via the near-simultaneous convergence of the separate predictors, although positive feedback may also be exploited to promote learning via initial divergence). Where the predictors employ a layered memory network (such as Bayesian layered network), convergence occurs in step-like manner.

The information flowing in the loop during these steps arises from the residual error energy in the predictions. The impedance cancellation is such that the machine controller reacts to these errors (including therefore any new information) relative to its effect on (a prediction of) the machine's energetic state (or some function thereof).

Where the predictors are arranged to drive “one-to-many” (nominally all) outputs, a rendering is apparent in the machine's interface (as “seen” by the machine controller) of its energetic self at the centre of its sensed environment cast as objects of energetic value to the machine. The model of itself is then orthogonal to the environment, and apparent always during divergence in the loop.

The invention further provides for machines comprising one or more interfaces, possibly in different environments, wherein the advantages of the invention are rendered across all the machine's interfaces. The invention can also be configured to accommodate more than one machine (controller), each with its own energetic state and drivers to nominally maintain that state.

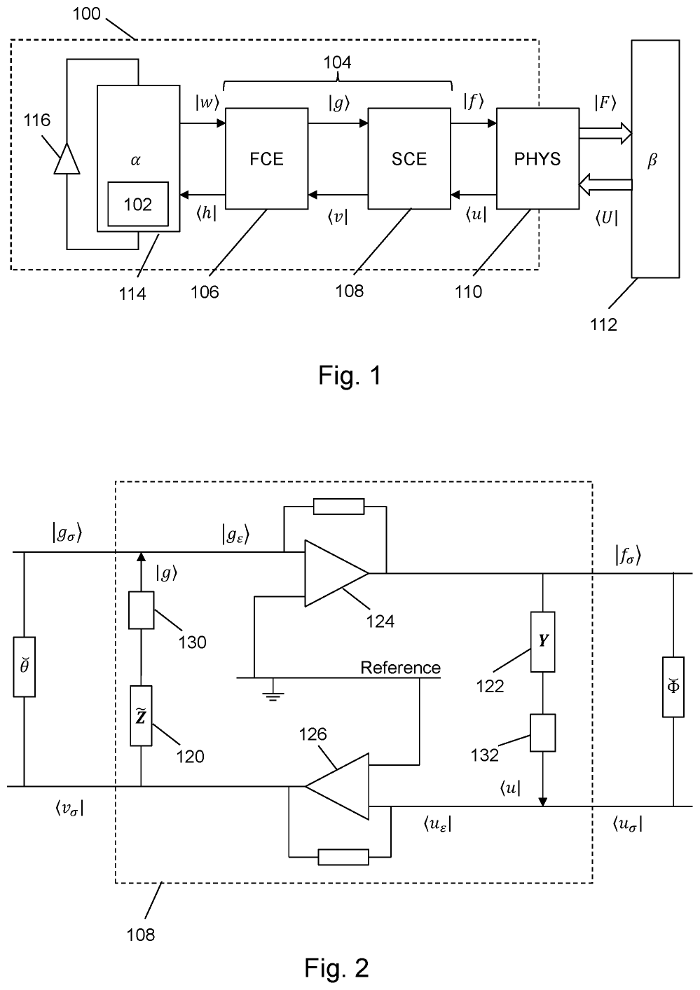

FIG. 1 is a schematic diagram showing the functional components of a machine 100 that is an embodiment of the invention. The machine 100 comprises an offline rechargeable power supply 102, a control system 104 and a physical interface 110 that represents the machine's ability to interact with its external environment 112, for example by providing mobility required to enable its engagement with an external energy source for power supply recharging.

The control system 104 includes a first control element 106 and a second control element 108 which interact to maintain the machine's positive energetic state via regulation of the machine and its internal environment 114, and the control of motion and interaction with its external environment 112.

The internal environments of a given machine is typically well understood, and is represented generally herein by a discrete matrix α. Conversely, the external environment is likely to be ever-changing and is defined by a more abstract matrix β.

In the discussion below, all indices referring to time are omitted for clarity. Moreover, the specific means of coding information in the control system 104 is not discussed in detail because it can be understood that a skilled person can implement the teaching below using known techniques. Indeed, the general machine architecture disclosed herein is amenable to a wide variety of implementations, and is applicable to autonomous machines suitable for use in many diverse applications.

In a general sense, it can be understood that the machine's physical interface 110 interacts with the external environment 112 in a variety of different ways that can be treated as a plurality of interfaces. An output |F [symbol] of the machine on these interfaces may manifest itself as a force exerted on the external environment, for example. Similarly, an input |U [symbol] to the machine on these interfaces may represent a measure of velocity or the like, from which a measure of physical resistance may be derived, for example.

The interfaces can fall into two categories: (i) reciprocal interfaces, and (ii) non-reciprocal interfaces. A reciprocating interface is one where the machine expends energy in a direct interaction with the external environment. In this embodiment, the control system is configured to operate the reciprocating interfaces in a common mode and a differential mode.

For m reciprocal interfaces, for the differential mode output,

$$\vert {F}_{m} 〉 = {Z}_{α} \vert {U}_{α} 〉 + {Z}_{β} \vert {U}_{m} 〉 = \vert {Z}_{α} + {Z}_{β} \vert {U}_{α} 〉 = {Z}_{m} \vert {U}_{m} 〉$$

$$\vert {U}_{m} 〉 = {Y}_{m} \vert {F}_{m} 〉$$

$${W}_{m} = 〈 {F}_{m} \vert {U}_{m} 〉 = 〈 {U}_{m} \vert {Z}_{m}^{†} \vert {U}_{m} 〉 = 〈 {F}_{m} \vert {Y}_{n}^{†} \vert {F}_{m} 〉$$

where Z_{α} and Z_{β} represent the mechanical impedances of the internal and external environments. Zₘ and Yₘ are matrices that represent respectively the impedance and admittance that relates the reciprocating outputs to the reciprocating inputs. Wₘ represents the power (or energy) expended by the machine through the reciprocal interfaces.

Meanwhile, for the common mode output, since Z_{β}|U₀ [symbol] =0,

$$\vert {F}_{0} 〉 = {Z}_{α} \vert {U}_{0} 〉$$

$$\vert {U}_{0} \} = {Y}_{α} \vert {F}_{0} 〉$$

$${W}_{0} = 〈 {F}_{0} \vert {U}_{0} 〉 = 〈 {U}_{0} \vert {Z}_{α}^{†} \vert {U}_{0} ) = 〈 {F}_{0} \vert {Y}_{α}^{†} \vert {F}_{0} 〉$$

The power expended on internal impedances can thus be expressed as

$${W}_{α} = 〈 {U}_{0} + {U}_{m} \vert {Z}_{α}^{†} \vert {U}_{0} + {U}_{m} 〉 = 〈 {F}_{0} + {F}_{m} \vert {Y}_{α}^{†} \vert {F}_{0} + {F}_{m} 〉$$

whilst for external impedances, since [symbol] Uₘ|Z_{α}^{†}|Uₘ [symbol] = [symbol] Fₘ|Y_{α}^{†}|Fₘ [symbol] =0

$${W}_{β} = 〈 {U}_{m} \vert {Z}_{β}^{†} \vert {U}_{m} 〉 = 〈 {F}_{m} \vert {Y}_{β}^{†} \vert {F}_{m} 〉$$

The mechanical efficiency of the machine in performing some mechanical action can be denoted by ηₘ where

$${η}_{m} = \frac{{W}_{β}}{{w}_{m}}$$

and where ηₘ is inversely proportional to the energetic stress on the machine.

The non-reciprocal interfaces are those through which information is conveyed in a manner where substantially no energy is lost into the external environment. The non-reciprocal interfaces comprise one or more non-reciprocal outputs and one or more non-reciprocal inputs. A non-reciprocal input may represent a sensor reading or other passive observation of the external environment, for example.

In a general sense, the machine 100 can be understood as having n non-reciprocal interfaces in total, consisting of p non-reciprocal output interfaces and q non-reciprocal input interfaces. By definition, |F_{q} [symbol] =0 and |Uₚ [symbol] =0, which means that the power expended through the n non-reciprocal interfaces is zero, i.e.

$${W}_{p} = 〈 {F}_{p} \vert {U}_{p} 〉 = 0$$

$${W}_{q} = 〈 {F}_{q} \vert {U}_{q} 〉 = 0$$

$${W}_{n} = {W}_{p} + {W}_{q} = 〈 {F}_{n} \vert {U}_{n} 〉 = 0$$

Considering then that the machine 100 has σ interfaces in total, where σ=m+n, it is possible to express the following relations concerning the total power (energy) expended by the machine:

$${W}_{σ} = {W}_{0} + {W}_{m} = {W}_{α} + {W}_{β}$$

The physical interface 110 can be understood as a functional entity that transforms between the interactions |F [symbol] , |U [symbol] with the external environment on the interfaces discussed above and control signals |f [symbol] , |u [symbol] exchanged with the control system 104 on a plurality of information channels. In a general sense the information channels can thus be categorised as reciprocal and non-reciprocal, even if there is not a one-to-one correlation between information channel and interface.

From the above, it can be understood that the m reciprocal channels may be energy preserving such that

$$〈 {f}_{m} \vert {u}_{m} 〉 = 〈 {F}_{m} \vert {U}_{m} 〉$$

$$〈 {f}_{0} \vert {u}_{0} 〉 = 〈 {F}_{0} \vert {U}_{0} 〉$$

It is also possible that energy preservation enables the number of reciprocating channels to be less than the number of reciprocating interfaces. For motion in one spatial dimension, at least two reciprocating interfaces are required, with one further interface required for each extra dimension.

For simplicity of the following explanation, it is assumed that |Fₚ [symbol] =|fₚ [symbol] for the p non-reciprocating outputs, and that |U_{q} [symbol] =|u_{q} [symbol] for the q non-reciprocating inputs.

More generally, a relationship between all input channels |uₗ [symbol] and all output channels |fₖ [symbol] , where k=m+p and l=m+q, can be expressed in terms of a matrix Φ that represents the physical interface. On the understanding that orthogonal common mode and differential mode signals are summed in the m reciprocating channels, this expression is:

$$\vert {u}_{1} \} = \vert \begin{matrix}{u}_{m} + {u}_{0} \\ {u}_{q}\end{matrix} 〉 = Φ \vert {f}_{k} 〉 = \vert \begin{matrix}{φ}_{11} & {φ}_{12} \\ {φ}_{21} & {φ}_{22}\end{matrix} \vert \begin{matrix}{f}_{m} + {f}_{0} \\ {f}_{p}\end{matrix} 〉$$

wherein Φ has units of mechanical admittance or mobility and represents the relationship between the input channels |u [symbol] and output channels |f [symbol] due to the combination of the physical interface and external environment, and where we define herein that

$${φ}_{11} = {Y}_{m}$$

It may be noted that there exists a power W_{Ξ} dissipated in the internal environment and control system, that is not related to the power expended for the operations of the machine discussed herein, but is present as a component of the differential equation that describes the overall energetic state E of the machine, where

$$\frac{dE}{dt} = {W}_{Ξ} + {W}_{β} + {W}_{α} = {W}_{Ξ} + {W}_{0} + {W}_{m}$$

The control system 104 (which can also be referred to as a “controller” herein) comprises a first control element 106 whose function is to regulate the internal environment 114, for example by employing a first feedback loop to control the internal environment of the machine, and a second feedback loop to cause the motion required to restore the offline power supply when necessary. For example, the first control element may provide a primary feedback loop that embeds sufficient positive feedback to promote energy expenditure, such as is required to locate and engage with an energy source required for power supply restoration, whilst simultaneously providing an over-arching negative feedback that promotes energy efficiency and strives to maintain the machine's positive energetic status. The first control element 106 thus comprises the required logic to instruct operation of the physical interface 110 to fulfil desired objectives, i.e. for the machine to function in the external environment.

Expressed in a general sense, the first control element 106 can be understood as interacting with the internal environment 114 through a set of j internally-facing input channels |w [symbol] and i internally-facing output channels |h [symbol] . Similarly, the first control element 106 can be understood as interacting with the physical interface with a set of externally-facing input channels |v [symbol] and externally-facing output channels |g [symbol] . In the invention, the set of externally-facing input channels |v [symbol] and externally-facing output channels |g [symbol] may map on to the input channels |u [symbol] and output channels |f [symbol] associated with the physical interface and therefore be considered as comprising k and l channels respectively, as discussed above. The above interactions of the first control element with the internal and external environments can be expressed as follows:

$$\vert {w}_{j} 〉 = α \vert {h}_{i} ,$$

$$and$$

$$\vert \begin{matrix}{g}_{k} \\ {h}_{i}\end{matrix} 〉 = β \vert \begin{matrix}{v}_{l} \\ {w}_{j}\end{matrix} 〉 = \vert \begin{matrix}{β}_{11} & {β}_{12} \\ {β}_{21} & {β}_{22}\end{matrix} \vert \begin{matrix}{v}_{l} \\ {w}_{j}\end{matrix} 〉$$

It follows that for the part of the element controlling motion

$$\vert {w}_{j} = {α [ I - {αβ}_{22} ]}^{- 1} {β}_{21} \vert {v}_{l} 〉$$

and therefore that

$$\vert {g}_{k} 〉 = {β}_{11} \vert {v}_{1} 〉 + {β}_{12} \vert {w}_{j} 〉 = \{ {β}_{11} + {β}_{12} {α [ I - α {β}_{22} ]}^{- 1} {β}_{21} \} \vert {v}_{l} 〉 = θ \vert {v}_{l} 〉$$

Thus, considering again that the orthogonal common mode and differential mode signals are summed in the m reciprocating channels, the following relation can be derived:

$$\vert {g}_{k} 〉 = \vert \begin{matrix}{g}_{m} + {g}_{0} \\ {g}_{p}\end{matrix} 〉 = θ \vert {v}_{l} 〉 = \vert \begin{matrix}{θ}_{11} & {θ}_{12} \\ {θ}_{21} & {θ}_{22}\end{matrix} \vert \begin{matrix}{v}_{m} + {v}_{0} \\ {v}_{q}\end{matrix} 〉$$

Here θ is a matrix having units of mechanical impedance and representing the relationship between the first control element's externally-facing input channels |v [symbol] and externally-facing output channels |g [symbol] due to the combination of the first control element and internal environment, and we define herein a notional impedance on the reciprocal channels as

$${\tilde{Z}}_{m} = {θ}_{11}$$

As discussed above, the control system is configured to operate the reciprocating interfaces in a common mode and a differential mode. In this embodiment, the first control element applies a common mode bias arranged such that the reciprocating interfaces have a positive internal power dissipation. Regulation of this internal dissipation is enabled via a common mode regulator 116 (e.g. a common mode servo amplifier) arranged in parallel with the internal environment 114, and configured to operate in either a feedback arrangement or feedforward arrangement (as a suitable component of α or β₂₂) relative to a reference. The reference may be a persistent energetic source formed in part from some positive feedback element that also serves as the fundamental source of the machine's overall positive energetic state.

The addition of the common mode regulator serves to maintain the common mode power output W₀ and steers the common mode signal away from β₁₁ via the pathway defined by β₂₂. By defining θ=A+B, where

$$A = {β}_{12} {α [ I - α {β}_{22} ]}^{- 1} {β}_{21}$$

$$and$$

$$B = {β}_{11}$$

further segmentation permits the definition

$${\tilde{Z}}_{m} = {\tilde{Z}}_{α} + {\tilde{Z}}_{β}$$

$$where$$

$${\tilde{Z}}_{α} = {A}_{11}$$

$$and$$

$${\tilde{Z}}_{β} = {B}_{11}$$

For the p non-reciprocating outputs |vₚ [symbol] =0 and for the q non-reciprocating inputs |g_{q} [symbol] =0, whereby the internal power expended is

$${\tilde{W}}_{p} = 〈 {g}_{p} \vert {v}_{p} 〉 = 0$$

$${\tilde{W}}_{q} = 〈 {g}_{q} \vert {v}_{q} 〉 = 0$$

and so for n non-reciprocating channels and o total channels

$${\tilde{W}}_{n} = 〈 {g}_{n} \vert {v}_{n} 〉 = 0$$

$${\tilde{W}}_{σ} = {\tilde{W}}_{0} + {\tilde{W}}_{m} = 〈 {g}_{0} \vert {v}_{0} 〉 + 〈 {g}_{m} \vert {v}_{m} 〉$$

Due to the action of the common mode regulator 116,

$${\tilde{W}}_{0} = 〈 {g}_{0} \vert {v}_{0} 〉 = 〈 {v}_{0} \vert {\tilde{Z}}_{α}^{†} \vert {v}_{0} \} = 〈 {g}_{0} \vert {\tilde{Y}}_{α}^{†} \vert {g}_{0} 〉$$

$${\tilde{W}}_{m} = 〈 {g}_{m} \vert {v}_{m} 〉 = 〈 {v}_{m} \vert {\tilde{Z}}_{n}^{†} \vert {v}_{m} 〉 = 〈 {g}_{m} \vert {\tilde{Y}}_{m}^{†} \vert {g}_{m} 〉$$

and thus that

$${\tilde{W}}_{α} = 〈 {v}_{0} + {v}_{m} \vert {\tilde{Z}}_{α}^{†} \vert {v}_{0} + {v}_{m} 〉 = 〈 {g}_{0} + {g}_{m} \vert {\tilde{Y}}_{α}^{†} \vert {g}_{0} + {g}_{m} 〉$$

$${\tilde{W}}_{β} = 〈 {v}_{m} \vert {\tilde{Z}}_{β}^{†} \vert {v}_{m} 〉 = 〈 {g}_{m} \vert {\tilde{Y}}_{β}^{†} \vert {g}_{m} 〉$$

The control system 104 further comprises a second control element 108 disposed between the first control element 106 and the physical interface 110. The second control element 108 mediates between the first control element 106 and physical interface 110 with an aim to offload the physical interface from the first control element and vice versa through the use of two predictive models discussed below.

In order to establish a real energetic basis on which to operate the predictive models within the second control element 108, the second control element 108 is configured to create an emulated reciprocal channel for each of the non-reciprocal channels that it handles. In this way four types of emulated reciprocal channel can be created:
an emulated reciprocal output channel provided in the set of externally-facing output channels |g [symbol] for each non-reciprocal channel in the set of externally-facing input channels |v [symbol] ,
an emulated reciprocal output channel provided in the set of output channels |f [symbol] for each non-reciprocal channel in the set of input channels |u [symbol] ,
an emulated reciprocal input channel provided in the set of externally-facing input channels |v [symbol] for each non-reciprocal channel in the set of externally-facing output channels |g [symbol] , and
an emulated reciprocal input channel provided in the set of input channels |u [symbol] for each non-reciprocal channel in the set of output channels |f [symbol] .

The common real energetic basis is established in the second control element 108 by the energy preserving link to external environment in the physical interface 110 discussed above. To take account of the emulated channels, it is useful to recast the k outputs and l inputs of the total number σ of interfaces in a more general formulation:

On an output side of the second control element:

$$\vert {u}_{σ} 〉 = \vert \begin{matrix}{u}_{m} + {u}_{0} \\ 0 \\ {u}_{1}\end{matrix} 〉 = Φ \vert {f}_{σ} 〉 = \vert \begin{matrix}{φ}_{11} & {φ}_{12} & 0 \\ 0 & 0 & 0 \\ {φ}_{21} & {φ}_{22} & 0\end{matrix} \vert \begin{matrix}{f}_{m} + {f}_{0} \\ {f}_{p} \\ 0\end{matrix} 〉$$

where if the non-reciprocal channels are expressed as

$$\vert {u}_{n} 〉 = \vert \begin{matrix}0 \\ {u}_{q}\end{matrix} 〉$$

$$and$$

$$\vert {f}_{n} 〉 = \vert \begin{matrix}{f}_{p} \\ 0\end{matrix} 〉$$

$$then$$

$$\vert {u}_{σ} 〉 = \vert \begin{matrix}{u}_{m} + {u}_{0} \\ {u}_{n}\end{matrix} 〉 = {Φ}^{⌣} \vert {f}_{σ} 〉 = \vert \begin{matrix}{{φ}^{⌣}}_{11} & {{φ}^{⌣}}_{12} \\ {{φ}^{⌣}}_{21} & {{φ}^{⌣}}_{22}\end{matrix} \vert \begin{matrix}{f}_{m} + {f}_{0} \\ {f}_{n}\end{matrix} 〉$$

$$where , notably$$

$${{φ}^{⌣}}_{11} = {φ}_{11}$$

and from which the remaining segments of Φ̆ follow. In can be understood that Φ̆ is a matrix representing an external world viewed by the second control element 108. It is referred to as the external matrix hereafter.

A similar approach can be taken on an input side of the second control element:

$$\vert {g}_{σ} 〉 = \vert \begin{matrix}{g}_{m} + {g}_{0} \\ {g}_{p} \\ 0\end{matrix} 〉 = θ \vert {g}_{σ} 〉 = \vert \begin{matrix}{θ}_{11} & 0 & {θ}_{12} \\ {θ}_{21} & 0 & {θ}_{22} \\ 0 & 0 & 0\end{matrix} \vert \begin{matrix}{v}_{m} + {v}_{0} \\ 0 \\ {v}_{q}\end{matrix} 〉$$

where if the non-reciprocal channels are expressed as

$$\vert {g}_{n} 〉 = \vert \begin{matrix}{g}_{p} \\ 0\end{matrix} 〉$$

$$and$$

$$\vert {v}_{n} 〉 = \vert \begin{matrix}0 \\ {v}_{q}\end{matrix} 〉$$

$$then$$

$$\vert {g}_{σ} 〉 = \vert \begin{matrix}{g}_{m} + {g}_{0} \\ {g}_{n}\end{matrix} 〉 = {θ}^{⌣} \vert {v}_{σ} 〉 = \vert \begin{matrix}{{θ}^{⌣}}_{11} & {{θ}^{⌣}}_{12} \\ {{θ}^{⌣}}_{21} & {{θ}^{⌣}}_{22}\end{matrix} \vert \begin{matrix}{v}_{m} + {v}_{0} \\ {v}_{n}\end{matrix} 〉$$

$$where , notably$$

$${{θ}^{⌣}}_{11} = {θ}_{11}$$

and from which the remaining segments of θ̆ follow. In can be understood that θ̆ is a matrix representing an internal world viewed by the second control element 108. It is referred to as the internal matrix hereafter.

The emulation of reciprocal channels provides for the creation of quasi-reciprocal channels that are (nominally) non-dissipating interface source or load terminations as appropriate, i.e. where

$$\vert {u}_{p} 〉 = I \vert {f}_{p} 〉$$

$$and$$

$$\vert {g}_{q} 〉 = I \vert {v}_{q} 〉$$

and |vₚ [symbol] and |f_{q} [symbol] are “open”. Note that the emulated non-reciprocal inputs or outputs used by the second control element 108 do not necessarily continue to the first control element 106 or physical interface 110. These unreturned channels can be understood as “stub” channels for the second control element 108.

As mentioned above, the second control element 108 provides two distinct predictive models, which independently model the information present by the reciprocal channels |g_{σ} [symbol] , |v_{σ} [symbol] and |f_{σ} [symbol] , |u_{σ} [symbol] . The predictive models can be implemented as feedforward or feedback elements using conventional techniques or rearranged with respect to each other in any known manner to achieve an equivalent effect.

FIG. 2 is a schematic diagram showing the interrelationship of the predictive models 120, 122 used in the second control element 108 in an embodiment of the invention. FIG. 2 depicts an implementation of the concepts in a simplified analogue circuit with a single channel solely for the purposes of illustration.

On the output side, a model Y 122 of the external matrix Φ̆ is developed or selected with the objective of minimising a first energy ε (or alternatively the “free energy” [symbol] u_{ε}|u_{ε} [symbol] in an input error vector |u_{ε} [symbol] ), where

$$ε = 〈 {f}_{σ} \vert {u}_{ε} 〉$$

$$\vert {u}_{ε} 〉 = \vert {u}_{σ} 〉 - \vert u 〉 = {Φ}^{⌣} \vert {f}_{σ} 〉 - Y \vert {f}_{σ} 〉 = {Y}_{ε} \vert {f}_{σ} 〉$$

$$ε = 〈 {f}_{σ} \vert {u}_{ε} ) = 〈 {f}_{σ} \vert {Y}_{ε} \vert {f}_{σ} 〉$$

$$and$$

$$\text{?} = [ \begin{matrix}{{φ}^{⌣}}_{11} - {Y}_{11} & {{φ}^{⌣}}_{12} - {Y}_{12} \\ {{φ}^{⌣}}_{21} - {Y}_{21} & {{φ}^{⌣}}_{22} - {Y}_{22}\end{matrix} ] = [ \begin{matrix}{Y}_{m} - {Y}_{11} & {{φ}^{⌣}}_{12} - {Y}_{12} \\ {{φ}^{⌣}}_{21} - {Y}_{21} & {{φ}^{⌣}}_{22} - {Y}_{22}\end{matrix} ]$$

$$\text{?} \text{indicates text missing or illegible when filed}$$

On the input side, a model \tilde{Z} of the internal matrix θ̆ is developed or selected with the objective of minimising a second energy ε (or alternatively the “free energy” [symbol] g_{ε}|g_{ε} [symbol] in an output error vector |g_{ε} [symbol] ), where

$$ε = 〈 {v}_{σ} \vert {g}_{ε} 〉$$

$$\vert {g}_{ε} 〉 = \vert \text{?} 〉 - \vert g 〉 = {θ}^{⌣} \vert \text{?} 〉 - \tilde{Z} \vert \text{?} 〉 = \text{?} \vert \text{?} 〉$$

$$ε = 〈 \text{?} \vert {g}_{ε} ) = 〈 \text{?} \vert \text{?} \vert \text{?} 〉$$

$$and$$

$$\text{?} = [ \begin{matrix}{{θ}^{⌣}}_{11} - {\tilde{Z}}_{11} & {{θ}^{⌣}}_{12} - {\tilde{Z}}_{12} \\ {{θ}^{⌣}}_{21} - {\tilde{Z}}_{21} & {{θ}^{⌣}}_{22} - {\tilde{Z}}_{22}\end{matrix} ] = [ \begin{matrix}{\tilde{Z}}_{m} - {\tilde{Z}}_{11} & {{θ}^{⌣}}_{12} - {\tilde{Z}}_{12} \\ {{θ}^{⌣}}_{21} - {\tilde{Z}}_{21} & {{θ}^{⌣}}_{22} - {\tilde{Z}}_{22}\end{matrix} ]$$

$$\text{?} \text{indicates text missing or illegible when filed}$$

In FIG. 2, a pair of operational amplifiers 124, 126 are depicted as each receiving a single channel for simplicity. These elements provide virtual earth “current” summing nodes, whilst two negative converters 130, 132 (e.g. negative impedance converters) act to invert the output of the models 120, 122 to achieve the cancellation effect. Each of the models 120, 122 may be understood as passive impedances, but which represent time varying, impulse impedance functions that act to modulate the impedances presented to a feedback loop set up within the second control element 108.

Each of the models 120, 122 may be generated by exploiting Bayesian layered networks. In general the models are arranged such as to present a negative impedance for the relevant channels, or in such arrangement to similar effect. The second control element 108 is arranged such that the predictions it forms from its model 122 of the external environment, even if from a single sensing input, is projected to nominally all the sensing inputs encompassed by the physical interface 110. As shown in FIG. 2, the predictive models 120, 122 are bound in a manner that means that in the absence of the models (i.e. without the second control element), the machine defaults to direct control of the physical interface 110 by the first control element 106.

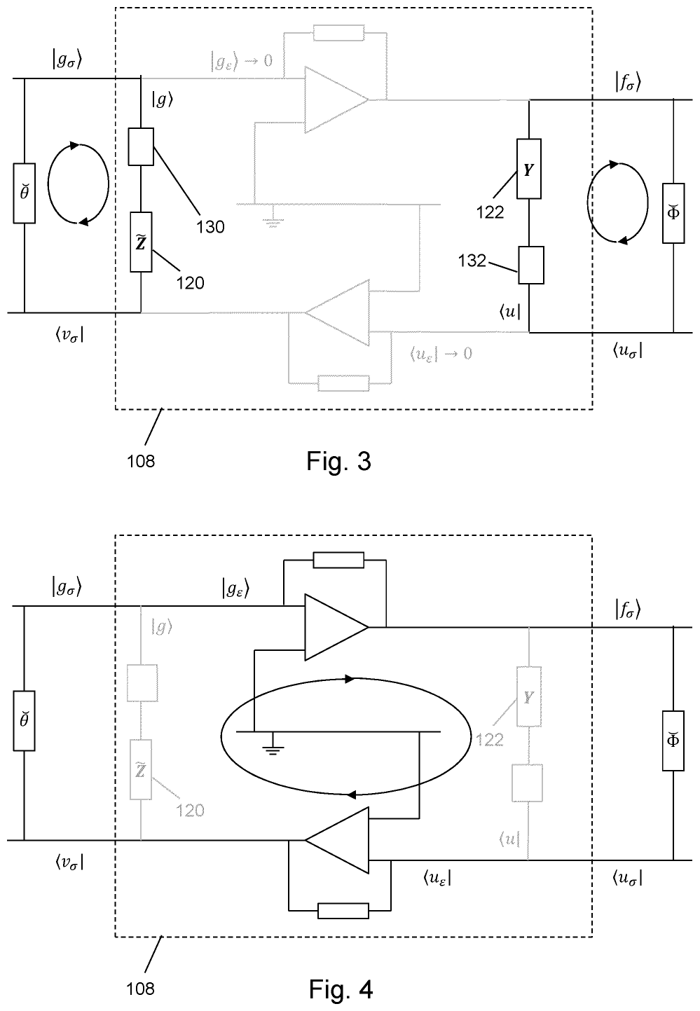

However, by implementing adaptive learning techniques in the second control element 108, the models 120, 122 can be adapted to progressively offload the physical interface 110 from the first control element 106 and vice versa. Where the models 120, 122 are of sufficient fidelity that no error energy ε is discerned, the models are operating in a converged state as depicted in FIG. 3. Here there is no flux in the binding of the models 120, 122, as

$$Y = {Φ}^{⌣} , \tilde{Z} = {θ}^{⌣} , 〈 {g}_{σ} \vert {v}_{σ} 〉 = 〈 {f}_{σ} \vert {u}_{σ} 〉$$

$$\tilde{Z} = {Y}^{- 1}$$

$$and$$

$${\tilde{Z}}_{m} = {Z}_{m}$$

$${\tilde{Z}}_{α} = {Z}_{α}$$

$${\tilde{Z}}_{β} = {Z}_{β}$$

When an error is apparent in the models 120, 122 (that is, when an unknown perturbation occurs), the binding flux establishes a feedback loop in the second control element 108 as shown in FIG. 4. The binding flux drives the models 120, 122 towards convergence again—either by selecting higher fidelity models or extracting (and possibly learning) new models. Since there error energy ε is bound to be the same in both predictive models,

$$ε = 〈 {f}_{σ} \vert {Y}_{ε} \vert {f}_{σ} 〉 = 〈 {V}_{σ} \vert {\tilde{Z}}_{ε}^{†} {Y}_{ε} {\tilde{Z}}_{ε} \vert {v}_{σ} 〉 = 〈 {v}_{σ} \vert {\tilde{Z}}_{ε} \vert {v}_{σ} 〉$$

$$such that$$

$${\tilde{Z}}_{ε} = {Z}_{ε}$$

The effect depicted in FIGS. 3 and 4 is that well-modelled parts of |g [symbol] and |u [symbol] cancel out, by appearing as an infinite impedance in parallel with the error impedances |g_{ε} [symbol] and |u_{ε} [symbol] formed by the non-modelled parts. Hence only currents due to the modelling errors flow in the local loop shown in FIG. 4, and thus the configuration shown provides for error “renormalisation”.

A maximally efficient model comprises a layered hierarchical structure, for example a Bayesian layered network as mentioned above. Convergence in such an arrangement is then step-like, as layers are selected and convergence occurs in progressive stages in the local feedback loop. When demand for convergence permits and where sufficient positive feedback is generated by the overall control loop, convergence might also entail further divergence (“wandering”) prior to convergence on some non-local point of equilibrium.

In the diverged state (FIG. 4), the model errors in the second control element can be observed at the physical interface, or at the point of reciprocating channel emulation. The errors may be effectively rendered at the physical interface in an appropriate sensory mode. Where the second control element employs a layered or hierarchical model, all layers below the source of the error are essentially cancelled out, such that the energetic information rendered in the physical interface is at the instants defining the path to convergence within the local feedback loop in the second control element, caused as higher hierarchical layers in the models are converged upon.

In more detail, during a period of divergence in the second control element (i.e. when Y_{ε} and \tilde{Z}_{ε} are non-zero) \tilde{W}_{α} will be non-zero even if Wₘ=0 because of the common mode servo action ensuring that W_{α}>0. Thus a component of \tilde{W}_{α} of the model error \tilde{Z}_{ε} will be apparent when there exists mechanical power output (via φ₁₁) or a prediction of mechanical power output (via φ₁₂) or a prediction of the effect of mechanical power output on the external environment (via φ₂₁) or (more obviously) if there is a perturbation in the machine's internal environment.

Layered models provide a lower hierarchical section for which no error is discerned, and a higher hierarchical section for which divergence is apparent. Due to the effective impedance cancellation provided by the predictive models, only the higher hierarchical layers appear in the effective loads rendered on the second control element.

The second control element thus provides for error “renormalisation”. More illustratively, the energetic error discerned in the model of the external environment is modulated by the demand determined by the respective part of the model of the first control element, and is subsequently rendered in potentially all the interfaces within the second control element.

Suitable model components for selection in assembling the predictive models 120, 122 may develop as Markov blankets formed around clusters of information that can be adequately described by a higher level, more efficient means. The model components can be formed by adaption or established in some pre-programmed form.

In one example, the second control element may be configured to force a predetermined degeneration terms in the first and second predictive models so that the gradually attenuate over time. In such a scheme, only those cross-terms that are reinforced by their frequent use persist and thus “memories” that are no longer relevant are discarded.

The architecture of the control system discussed above, in particular the provision of the common mode regulator and the reciprocal channel emulation enables the predictive models to discriminate between various clusters of information. At a fundamental layer of the models, and for the renormalised steps to convergence, in use there will exist a cluster of information in the binding flux in the second control element that represents a measure of the physical energetic machine itself and its action relative to its energetic state, and wherein there will exist a cluster of information (or object) correlated to the mechanical power output or prediction thereof (that defines the machine's near field), that can be discriminated from the information that has no correlation with the machine's mechanical power output or prediction thereof (that forms the machine's sensed far field).

For the cluster of information defining the near field, further discrimination afforded by the common mode servo and the correlation of the common mode and differential mode power outputs, provides a relative measure of the internal power dissipation or prediction thereof, and a measure represents the external mechanical power dissipation or a prediction thereof, such that there is inferred a cluster of information representing the machine itself, that is distinct from its far field according to the bounding inherent in its mechanical interactions, and is subject to an energetic stress over which some degree of agency is apparent, where the agency includes that determining the steps to convergence within the second control element, and that determining the actions due to the first control, and where the renormalised error is effectively rendered, such as to provide a focussed window of the machine's entire sensed reality, based upon the relative energetic value to the machine of that part of sensed reality as determined by the renormalisation of the first control element output.

It may be noted that the rendering of a relative energetic measure is only apparent in the period after a model error is discerned and until convergence reached. The rendering may therefore be asynchronous and occur at discrete instants of real time.

The first control element may be configured to operate relative to a reference, which may be indicative of a positive energetic state of the machine. In one example, the machine may emulate a thermogenic machine by configuring the reference to be indicative of an internal temperature of the machine. For example, the reference may be provided by an output from a common mode regulator that has one or more thermometers that sense the internal temperature of the machine. The machine may thus be configured to control its own heating via modulation of the common mode power output.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

[1] Linsker (1988) “Self-organization in a perceptual network”. IEEE Computer, 21(3), 105-117
[2] Dayan (1995) “The Helmholtz Machine”. Neural Comput. 7, 889-904
[3] Friston (2006) “A Free Energy Principle for the Brain”. J. Physiol. Paris 100, 70-87
[4] Feynman (1972) “Statistical Mechanics: A Set of Lectures”. Benjamin ISBN 9-7800805-325093
[5] Mackay (2003) “Information Theory, Inference, and Learning Algorithms”. Cambridge University Press ISBN 9-780521-642989
[6] Tishby (1999) “The Information Bottleneck Method”. 37th Allerton Conference on Communication, Control, and Computing 368-377
[7] Friston (2008) “Hierarchical Models in the Brain”. PLOS Comput. Biol. 4(11)

1. A machine capable of autonomous operation, the machine comprising:
a rechargeable offline power supply;
a physical interface through which the machine interacts with an external environment, the physical interface comprising:
a reciprocating interface operable in a differential mode and a common mode, wherein the reciprocating interface is configured to provide motion via a differential mode output, and to provide motion cancellation of a common mode output; and
a non-reciprocating interface configured to interact passively with the external environment via a non-reciprocating input;
a first control element configured to control internal and external operations of the machine and maintain a positive energetic state of the machine; and
a second control element disposed between the first control element and the physical interface to mediate information exchange therebetween,
wherein the second control element is configured to communicate with the physical interface via a first set of reciprocal information channels and to communicate with the first control element via a second set of reciprocal information channels,
wherein the first set of reciprocal information channels includes an input channel configured to convey information into the machine from the non-reciprocating input and an emulated output channel that forms a reciprocal pair with the input channel,
wherein the second control element comprises a first predictive model arranged to predict communications on the first set of reciprocal information channels, and a second predictive model arranged to predict communications on the second set of reciprocal information channels,
wherein the first predictive model and the second predictive model are both adaptive models bound in a feedback arrangement to minimise an error energy flux between the first and second sets of reciprocal information channels, and
wherein the first control element is configured to maintain a common mode bias at the physical interface, and comprises a common mode regulator arranged to establish an independent parallel common mode path within the internal environment of the machine.

2. A machine according to claim 1, wherein the differential mode output of the reciprocating interface is configured to move the machine within the external environment, and wherein the reciprocating interface comprises at least one independent pair of reciprocating elements per dimension of movement.

3. A machine according to claim 1, wherein the first control element is configured to regulate the machine's positive energetic state.

4. A machine according to claim 3, wherein the first control element is implemented by a control model that encodes instructions capable of controlling the physical interface to enable the machine to perform actions in its environment, wherein the control model is configured to operate based on an internal reference that is indicative of the energetic state of the machine, and wherein the control model adopts a first feedback loop to control the internal environment of the machine, and a second feedback loop to cause the motion required to restore the offline power supply.

5. A machine according to claim 4, wherein the control model comprising a plurality of driver units that are arranged to determine a priority for a set of available actions, and wherein the plurality of driver units comprise a fundamental driver followed by a cascade of subsidiary drivers, wherein the fundamental driver is configured to maintain the machine's positive energy state, and wherein the first control element is configured to suspend one or more subsidiary drivers during an initial operational period.

6-7. (canceled)

8. A machine according to claim 4, wherein the first control element comprises an adaptive learning module arranged to update the control model.

9. A machine according to claim 1, wherein the common mode regulator is driven by an internal reference signal that is indicative of the machine's positive energetic state.

10. A machine according to claim 1, wherein the common mode bias maintained by the first control element is arranged to cause the common mode output of the reciprocating interface to have a positive internal power dissipation, wherein the common mode regulator is configured to regulate the internal power dissipation to control an internal temperature of the machine.

11. A machine according to claim 1, wherein the first set of reciprocal information channels and the second set of reciprocal information channels each comprise a plurality of reciprocating channel pairs that establish a real energetic basis in the second control element.

12. A machine according to claim 1, wherein the non-reciprocating interface comprises a non-reciprocating output, and wherein the first set of reciprocal information channels further includes an output channel conveying information to the non-reciprocating output, and an emulated input channel that forms a reciprocal pair with the output channel.

13. A machine according to claim 1, wherein the first and second sets of reciprocal information channels each comprise a plurality of non-reciprocating channel pairs, each channel pair consisting of a non-reciprocal that is sourced from either the first control element or the physical interface, and a corresponding emulated channel, and wherein one or more of the non-reciprocating channel pairs terminate before the first control element or the physical interface, thereby formed a stub channel.

14. (canceled)

15. A machine according to claim 1, wherein the first predictive model is configured to generate an output that comprises a signal on all of the first set of reciprocal information channels and the second predictive model is configured to generate an output that comprises a signal on all of the second set of reciprocal information channels.

16. A machine according to claim 1, wherein the first predictive model and second predictive model operate towards a converged state in which the energy flux between the first and second sets of reciprocal information channels is a minimum, wherein the second control element is configured to control a pathway to the converged state in a stepwise manner, and wherein, when in a diverged state, the second control element is arranged to identify an observable rendering of the energy flux between the first and second sets of reciprocal information channels at the physical interface, and control the pathway to the converged state based on the identified rendering.

17. (canceled)

18. A machine according to claim 16, wherein the second control element is configured to modulate the pathway to the converged state.

19. A machine according to claim 1 configured in a distributed manner over a plurality of physical sub-components.

20. A machine according to claim 1, wherein the first control element is configured to generate non-linear response on one or more of the second set of reciprocal information channels.

21. A machine according to claim 1, wherein the second control element is arranged to introduce a perturbation in the first predictive model and/or the second predictive model.

22. A method of operating an autonomous machine, the machine comprising:
a rechargeable offline power supply;
a physical interface through which the machine interacts with an external environment, the physical interface comprising:
a reciprocating interface operable in a differential mode and a common mode, wherein the reciprocating interface is configured to provide motion via a differential mode output, and to provide motion cancellation of a common mode output; and
a non-reciprocating interface configured to interact passively with the external environment via a non-reciprocating input;
a first control element configured to control internal and external operations of the machine and maintain a positive energetic state of the machine; and
a second control element disposed between the first control element and the physical interface to mediate information exchange therebetween,
wherein the second control element is configured to communicate with the physical interface via a first set of reciprocal information channels and to communicate with the first control element via a second set of reciprocal information channels,
wherein the first set of reciprocal information channels includes an input channel configured to convey information into the machine from the non-reciprocating input and an emulated output channel that forms a reciprocal pair with the input channel,
wherein the second control element comprises a first predictive model arranged to predict communications on the first set of reciprocal information channels, and a second predictive model arranged to predict communications on the second set of reciprocal information channels,
wherein the first predictive model and the second predictive model are both adaptive models bound in a feedback arrangement to minimise an error energy flux between the first and second sets of reciprocal information channels,
wherein the first control element is configured to maintain a common mode bias at the physical interface, and comprises a common mode regulator arranged to establish an independent parallel common mode path within the internal environment of the machine, and
wherein the method comprises:
determining an error energy flux between the first and second sets of reciprocal information channels based on an observable property of the physical interface;
adapting one or both of the first predictive model and the second predictive model based on the determined error energy flux.

23. A method according to claim 22, wherein the first predictive model and the second predictive model each comprise a layered hierarchical model, and wherein adapting one or both of the first predictive model and the second predictive model comprises selecting a layer to add to or change in each hierarchical model to reduce the error energy flux.

24. A computer program product comprising computer readable instructions stored on a non-transitory carrier, wherein the computer readable instructions are executable by a computer to perform a method according to claim 22.
